(19) United States
(12) Patent Application Publication
(10) Pub. No.: US 2010/0154677 A1
(43) Pub. Date: Jun. 24, 2010

(54) Process for Incorporating Effect Pigments with Natural Fibers and Oils

(76) Inventor: Doreen C. BECKER, Pleasantville, NY (US)

Correspondence Address: BASF CATALYSTS LLC, 100 CAMPUS DRIVE, FLORHAM PARK, NJ, 07932, US

(21) Appl. No.: 12/641,414

(22) Filed: Dec. 18, 2009

Related U.S. Application Data
(60) Provisional application No. 61/139,011, filed on Dec. 19, 2008.

(51) Int. Cl. C08K 5/00; C08K 3/10; C08K 3/20; C11C 3/00

(52) U.S. Cl. 106/406; 106/400; 106/401; 106/504

(57) ABSTRACT

This application is directed to a process for incorporating effect pigments with natural fibers and oils, the process combining the effect pigments with natural fibers and oils prior to processing in heated applications.

### FIELD OF THE INVENTION

This application is directed to a process for preparing products that incorporates therein effect pigments and other materials including natural fibers and oils.

### BACKGROUND OF THE INVENTION

Imparting a pearlescent luster, metallic luster and/or multi-color effects approaching iridescent can be achieved using a nacreous or pearlescent pigment which comprises a metal oxide-coated platelet. These pigments were first described in U.S. Pat. Nos. 3,087,828 and 3,087,829 and a description of their properties can be found in the Pigment Handbook, Vol. I, Second Edition, pp. 829-858, John Wiley & Sons, N.Y. 1988. These pigments have been instrumental in countless applications in the cosmetics, automotive and industrial areas.

In marketing certain products, the consumers are inclined to have greater interests in product coverings and other identifications in which the customers can better identify the products through various senses. For example, perfume advertisements may be marketed through literature inserts in periodicals, in which the potential consumers of the products may smell the perfume that is incorporated in the literature inserts.

Another way to market a product may be to incorporate the natural ingredients so that the consumer may feel the texture of the raw products. For example, incorporation of coconut shavings on the surface of the product covering or other product identification will allow the

Because the sensual nature of the products imparts a more pronounced way for the consumer to identify with the product, the packaging may contain certain characteristics of a product. For example, coconut shavings can be used in the packaging so that a consumer can see, touch and/or smell the packaging to see the product has a coconut characteristic.

Effect pigment involved the incorporation of plays a major role in the industry. The cosmetic industry heavily relies on effect pigments to provide attractiveness to the packaging as well as to impact a pleasing color.

### SUMMARY OF THE INVENTION

This application is directed to a process for incorporating effect pigments with natural fibers and oils, the process combining the effect pigments with natural fibers and oils prior to processing in heated applications.

### DETAILED DESCRIPTION OF THE INVENTION

Natural fibers and oils are combined with effect pigments prior to processing in heated applications including but not limited to injection molding, blow molding, rotational molding, sheet and film extrusions, pellet, strand, strip and profile extrusion with thermoplastic and thermoset resins and polymers. This may also include processing and applications with liquid and powder paints, inks and casting resins.

Metal oxide coated effect pigments were blended with natural fibers such as bamboo, cedar, oatmeal, lavender, eucalyptus, cork, sea kelp and olive wood. Essential oils of lavender, green tea, eucalyptus and various flower extracts were also added into the blend. It is commonly held that these organic substances cannot withstand the high processing temperatures that are used in many of the above-mentioned applications. The unique insulating properties of effect pigments contribute to the stability of these organic substances and partially prevents them from decomposition by insulating or absorbing some of the heat from the processing.

### EXAMPLES

The following are examples of experiments performed to manufacture the products that incorporate effect pigments with natural fibers and oil.

### Example 1

### Spinach Pasta

489.5 g polypropylene
0.5 g mineral oil

### 3.75 g Adobe Green

### 0.50 g Black Olive (9000Z)

1.25 g iron flake

### 5.0 g ACP-8A

### Example 2

### Eggplant Pasta

438.0 g polypropylene
0.5 g mineral oil

### Add: 3.75 g 9650Z(Super Blue Russet)

2.50 g MP-4000

42.0 g Sea Kelp

100 g ACP-8A

5 drops of Lemon Grass

### Example 3

### Tomato Pasta

448.0 g polypropylene
0.5 g mineral oil

### Add: 5.0 g 9450D (Lumina Russet)

42 g Sea kelp

5.0 g ACP-8A

5 drops Lemon Grass

### Example 4

### Cork

462.0 g polypropylene
0.5 g mineral oil

### Add: 5.0 g MP-3000

28.0 g Cork

50 g ACP-8A

### Example 5

### Sawdust with Magnapearl™ Effect Pigment in Polypropylene Half Round Caps

480.0 g polypropylene

0.5 g mineral oil

### add: 5.0 g Magnapearl (3000 MP-3000)

10.0 g Sawdust

5.0 g ACP-8A

### Example 6

### Sawdust with Magnapearl™ Effect Pigment in Polypropylene Half Round Caps

440.0 g polypropylene

0.5 g mineral oil

### add: 50.0 g Sawdust

5.0 g magnapearl 30000 (MP-3000)

5.0 g ACP-8A

### Example 7

### Sawdust with Magnapearl™ Effect Pigment in Polypropylene Half Round Caps

365.0 g polypropylene

0.5 g mineral oil

### add: 5.0 g Magnapearl 3000 (MP-3000)

125.0 g Sawdust

5.0 g ACP-8A

### Example 8

### Sawdust with Magnapearl™ Effect Pigment in Polypropylene Half Round Caps

450.0 g polypropylene

0.5 g mineral oil

5 drops Lavender scent

### Add: 5.0 g MP-3000

40.0 g seeds [lavender seeds]

5.0 g ACP-8A

Various embodiments of this invention are described herein, including the best mode known to the inventors for carrying out the invention. It should be understood that the illustrated embodiments are exemplary only, and should not be taken as limiting the scope of the invention.

What is claimed is:

1. A process for incorporating effect pigments with natural fibers and oils, the process combining the effect pigments with natural fibers and oils prior to processing in heated applications.

2. The process of claim 1 wherein the heated applications comprises injection molding, blow molding, rotational molding, sheet and film extrusions, pellet, strand, strip and profile extrusion with thermoplastic and thermoset resins and polymers.

3. The process of claim 1 wherein the effect pigments are metal oxide coated.

4. The process of claim 1 wherein the effect pigment is metal oxide coated effect pigments.

5. The process of claim 1 wherein the natural fibers comprises as bamboo, cedar, oatmeal, lavender, eucalyptus, cork, sea kelp and olive wood.

6. The process of claim 1 wherein the essential oils of lavender, green tea, eucalyptus and various flower extracts were also added into the blend.
